(19) United States
(12) Patent Application Publication
(10) Pub. No.: US 2006/0150683 A1
(43) Pub. Date: Jul. 13, 2006

(54) Apparatus and method for glass sheet quenching

(75) Inventor: Troy R. Lewandowski, Maumee, OH (US)

Correspondence Address: BROOKS KUSHMAN P.C., 1000 TOWN CENTER, TWENTY-SECOND FLOOR, SOUTHFIELD, MI, 48075, US

(73) Assignee: Glasstech, Inc., Perrysburg, OH (US)

(21) Appl. No.: 11/032,921

(22) Filed: Jan. 11, 2005

(51) Int. Cl. C03B 27/00; C03B 13/16

(52) U.S. Cl. 65/114; 65/370.1; 65/348

(57) ABSTRACT

An apparatus for quenching a heated glass sheet includes a roll conveyor system for conveying the glass sheet in a direction of conveyance C generally along a plane of conveyance. The apparatus further has upper and lower sets of flow control members respectively located above and below the plane of conveyance. Each set includes multiple flow control members that each have multiple outlets for supplying quenching fluid for impingement with the glass sheet in inclined directions both upstream and downstream with respect to the direction of conveyance C. Moreover, each outlet provides a fluid flow path to the conveyed glass sheet. For each flow control member viewed in a direction generally transverse to the direction of conveyance C, the flow paths define a maximum angle of less than 75 degrees.

### BACKGROUND OF THE INVENTION

1. Field of the Invention

The invention relates to an apparatus and method for glass sheet quenching.

2. Background Art

Quenching apparatuses may be used to temper or strengthen glass sheets. Examples of prior quenching apparatuses are disclosed in U.S. Pat. Nos. 4,515,622 and 5,273,568.

### SUMMARY OF THE INVENTION

Under the invention, an apparatus for quenching a heated glass sheet is provided. In one embodiment, the apparatus includes a roll conveyor system for conveying the glass sheet in a direction of conveyance C generally along a plane of conveyance. The apparatus further has upper and lower sets of flow control members respectively located above and below the plane of conveyance. Each set includes multiple flow control members that each have multiple outlets for supplying quenching fluid for impingement with the glass sheet in inclined directions both upstream and downstream with respect to the direction of conveyance C. Moreover, each outlet provides a fluid flow path to the conveyed glass sheet. For each flow control member viewed in a direction generally transverse to the direction of conveyance C, the flow paths define a maximum angle of less than 75 degrees.

In another embodiment, the apparatus includes a roll conveyor system configured to convey the glass sheet in a direction of conveyance C generally along a plane of conveyance. The apparatus further includes upper and lower sets of flow control members respectively located above and below the plane of conveyance. Each set includes multiple flow control members that each have a nozzle portion including multiple outlets for supplying quenching fluid for impingement with the glass sheet, and a main body portion connected to the nozzle portion for receiving the quenching fluid and supplying the quenching fluid to the nozzle portion. Each nozzle portion and each main body portion have an internal width generally in the direction of conveyance C. For each flow control member, the internal width of the main body portion is at least 50 percent larger than the internal width of the nozzle portion.

In yet another embodiment, the apparatus includes a conveyor system configured to convey the glass sheet in a direction of conveyance C generally along a plane of conveyance. The conveyor system includes multiple rolls extending generally transverse to the direction of conveyance C, and multiple supports that are each engageable with a respective roll for supporting an intermediate portion of the roll. The apparatus further includes upper and lower sets of flow control members respectively located above and below the plane of conveyance. Each set has multiple flow control members that each have multiple outlets for supplying quenching fluid for impingement with the glass sheet.

Further under the invention, a method is provided for quenching a heated glass sheet. The method includes the steps of conveying the glass sheet in a direction of conveyance C generally along a plane of conveyance; and supplying quenching fluid to upper and lower sets of flow control members respectively located above and below the plane of conveyance, each set including multiple flow control members that each have multiple outlets for supplying the quenching fluid for impingement with the glass sheet in inclined directions both upstream and downstream with respect to the direction of conveyance C, each outlet providing a fluid flow path to the conveyed glass sheet, and wherein for each flow control member viewed in a direction generally transverse to the direction of conveyance C, the flow paths define a maximum angle of less than 75 degrees.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a side view of a glass sheet quench system according to the invention including a furnace and a quench apparatus, wherein the quench apparatus includes multiple upper and lower blastheads;

FIG. 2 is a front view of the quench apparatus;

FIG. 3 is a fragmentary cross-sectional view of the quench apparatus viewed in the same direction as in FIG. 1;

FIG. 4 is a plan view of a portion of one of the lower blastheads;

FIG. 5 is a fragmentary view of a flow control member of one of the lower blastheads, with a portion enlarged to show features of the flow control member;

FIG. 6 is a view that illustrates a pattern of impingement locations of fluid flow paths with a conveyed glass sheet;

FIG. 7 is a plan view of one of the lower blastheads showing multiple roll supports that support rolls of the quench apparatus;

FIG. 8 is a side view of one of the roll supports; and

FIG. 9 is a front view of the roll support of FIG. 8.

### DETAILED DESCRIPTION OF THE PREFERRED EMBODIMENT(S)

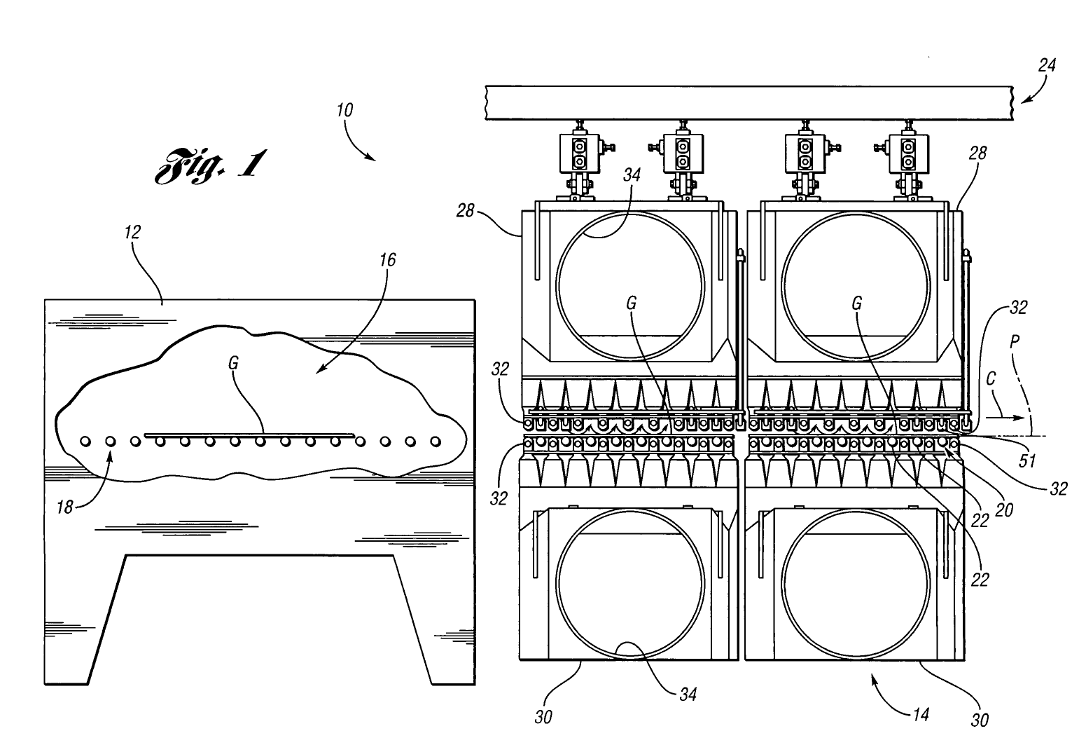

FIG. 1 shows a glass sheet quench system 10 for providing heat strengthening or tempering. The system 10 includes a furnace 12 in which glass sheets G are heated, and a quench apparatus 14 for quenching the heated glass sheets G. The furnace 12 includes a heating chamber 16 for heating glass sheets G in any suitable manner, and a roll conveyor system 18 for moving each glass sheet G through the furnace 12.

After sufficient heating to permit heat strengthening or tempering, each glass sheet G is conveyed from the furnace 12 to the quench apparatus 14. The glass sheet conveyance may be in a single direction from the left toward the right, or may be in an oscillating fashion in the furnace 12 and/or the quench apparatus 14.

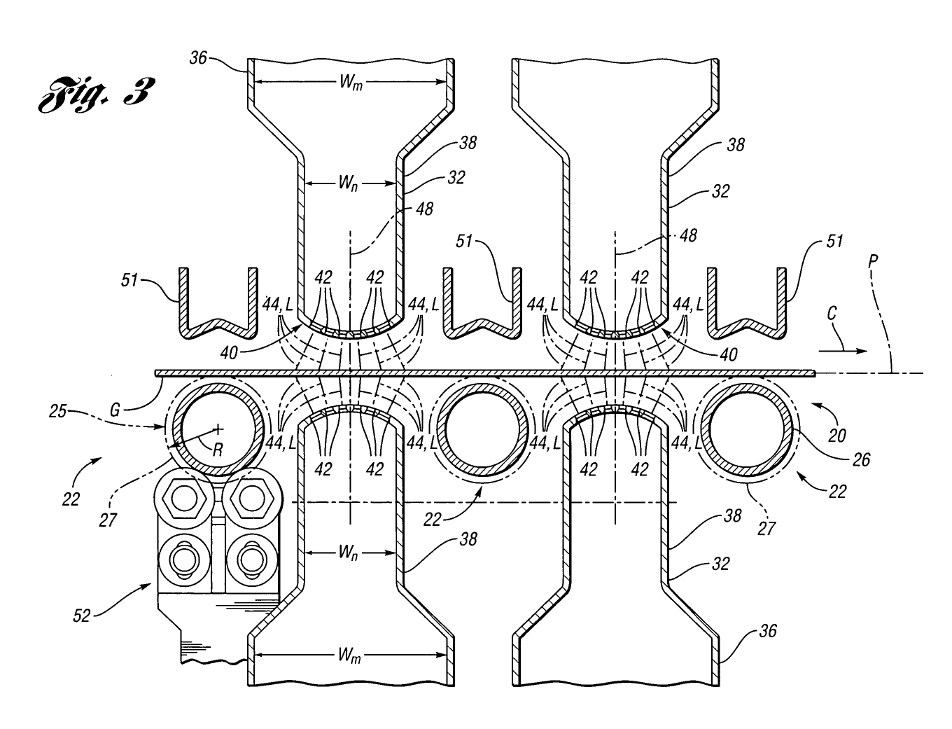

Referring to FIGS. 1-3, the quench apparatus 14 includes a roll conveyor system 20 having multiple horizontally extending conveyor rolls 22 that convey glass sheets G in a direction of conveyance C generally along a plane of conveyance P. The rolls 22 may be supported by a support structure, such as a frame 24 that allows the rolls 22 to rotate. Furthermore, each roll 22 has an outer conveying surface 25 having a radius R that may be provided by any suitable construction. Referring to FIG. 4, for example, each roll 22 may include a roll body 26 and a helically wrapped support member 27 that defines the conveying surface 25. The support member 27, which may comprise woven aromatic polyamide fibers or any other suitable material, is configured to effectively convey glass sheets G without marking their heat softened lower surfaces prior to cooling.

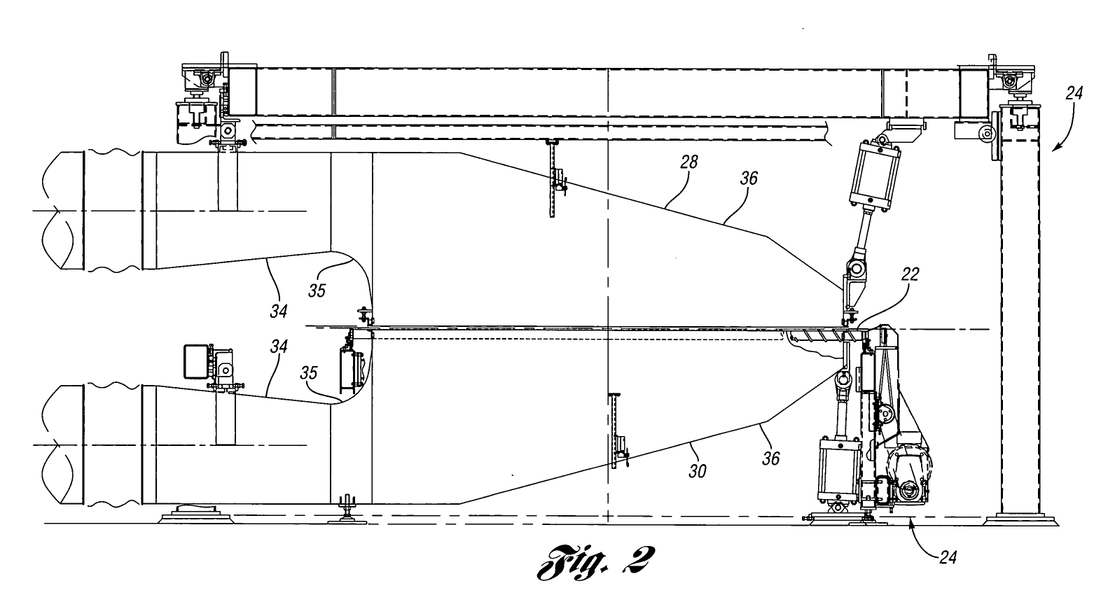

Referring to FIGS. 1 and 2, the apparatus 14 further includes one or more upper flow heads, such as upper blastheads 28, and one or more lower flow heads, such as lower blastheads 30, that may each be supported by the frame 24. Each blasthead 28 and 30 includes multiple elongated flow control members 32, such as fins, and a supply duct 34 connected to the flow control members 32 via duct transition portion 35. The supply ducts 34 are configured to receive quenching fluid, such as air, from a source of quenching fluid (not shown), and to supply the quenching fluid to the flow control members 32.

Referring to FIGS. 2 and 3, each flow control member 32 has a main body portion 36, such as a plenum portion, connected to a respective supply duct 34 for receiving quenching fluid therefrom, and a nozzle portion 38 connected to the main body portion 36 for receiving quenching fluid therefrom and for supplying the quenching fluid for impingement with a glass sheet G. Furthermore, for each flow control member 32, the main body portion 36 and the nozzle portion 38 have substantially the same length generally transverse to the direction of conveyance C. Referring to FIG. 2, each main body portion 36 tapers in height from a first end, which is connected to supply duct 34 via duct transition portion 35, to an opposite second end.

Referring to FIGS. 3 and 5, each main body portion 36 and nozzle portion 38 has an internal width wₘ and wₙ, respectively, generally in the direction of conveyance C. In the embodiment shown in FIGS. 3 and 5, the internal width wₘ of each main body portion 36 is larger than the internal width wₙ of the associated nozzle portion 38. For example, the internal width wₘ of each main body portion 36 may be in the range of 50 to 150% larger than the internal width wₙ of the associated nozzle portion 38. As another example, the internal width wₘ of each main body portion 36 may be in the range of 75 to 125% larger than the internal width wₙ of the associated nozzle portion 38. In one embodiment, the internal width wₘ of each main body portion 36 is in the range of 5.97 to 7.24 centimeters (2.35 to 2.85 inches), and the internal width wₙ of each nozzle portion 38 is in the range of 2.54 to 3.81 centimeters (1 to 1.5 inches). In another embodiment, the internal width wₘ of each main body portion 36 is in the range of 6.287 to 6.922 centimeters (2.475 to 2.725 inches), and the internal width wₙ of each nozzle portion 38 is in the range of 2.856 to 3.493 centimeters (1.125 and 1.375 inches).

With such a configuration, flow through the flow control members 32 may be optimized, while enabling the nozzle portions 38 of the flow control members 32 to be positioned relatively close to conveyed glass sheets G and between conveyor rolls 22. For example, with the larger width of the main body portions 36, flow losses along the length of each flow control member 32 may be reduced, thereby providing relatively uniform pressure and flow along each flow control member 32.

Referring to FIG. 3, each nozzle portion 38 includes a curved exterior surface 40 having multiple outlets 42 for supplying quenching fluid for impingement with a glass sheet G in inclined directions both upstream and downstream with respect to the direction of conveyance C. While each exterior surface 40 may have any suitable curvature, in one embodiment of the invention, each exterior surface 40 has a radius of curvature of at least 2.54 centimeters (1 inch). In another embodiment, each exterior surface 40 has a radius of curvature of at least 2.79 centimeters (1.10 inches).

Referring to FIGS. 3 and 5, each outlet 42 has a hydraulic diameter D and provides a fluid flow path 44 having a length L from exterior surface 40 to the conveyed glass sheet G. For each flow control member 32 viewed in a direction generally transverse to the direction of conveyance C, the flow paths 44 define a maximum angle of less than 75 degrees. In one embodiment, the flow paths 44 define a maximum angle of less than 60 degrees. In the embodiment shown in FIG. 5, the flow paths 44 define a maximum angle α of less than 52 degrees. For example, angle α may be 51.25 degrees.

Moreover, in the embodiment shown in FIG. 5, the flow paths 44 of intermediate outlets 42 define an angle β in the range of 25 to 35 degrees, and the flow paths of the innermost outlets 42 define an angle γ in the range of 8 to 14 degrees. For example, angle β may be 30.26 degrees, and angle γ may be 10.99 degrees.

With the configuration described above, heat transfer between the quenching fluid and the glass sheets G may be improved compared to prior quenching systems. For example, by reducing the maximum angle defined by the flow paths 44 below 75 degrees, and preferably below 52 degrees, deflection of quenching fluid off of boundary layers of air along top and bottom surfaces of the glass sheets G may be reduced. As a result, such boundary layers of air may be effectively disrupted by the quenching fluid, thereby creating turbulent flow proximate top and bottom surfaces of the glass sheets G.

Furthermore, the distance between the nozzle portions 38 and the glass sheets G may be reduced to improve heat transfer. For example, the quench apparatus 14 may be configured such that the length L of each flow path 44 is less than 4.5 times the diameter D of the associated outlet 42 (L/D<4.5). As another example, the quench apparatus 14 may be configured such that the length L of each flow path 44 is less than 4.2 times the diameter D of the associated outlet 42 (L/D<4.2). In yet another example, the quench apparatus 14 may be configured such that the length L of each flow path 44 is less than or equal to 4 times the diameter D of the associated outlet 42 (L/D≦4). With such flow path lengths, the quenching fluid supplied by the outlets 42 may have a higher velocity and be more concentrated upon impingement with the glass sheets G compared to prior quenching systems.

Referring to FIGS. 3-5, the outlets 42 may have any suitable shape, size and orientation. For example, each outlet 42 may have a generally cylindrical portion that extends to the associated exterior surface 40 and defines the diameter D, and a chamfered inlet portion 46. Moreover, each flow control member 32 may have multiple different sizes of outlets 42. For example, each flow control member 32 may have three different sizes of outlets 42, with the smallest outlets 42 having the shortest flow path length L and an angle of incidence closest to a perpendicular relationship with the glass sheet plane of conveyance P. In one embodiment of the invention having three different sizes of outlets 42, the smallest outlets 42 may have a diameter D in the range of 2.44 to 2.54 millimeters and a flow path length L in the range of 9.98 to 10.38 millimeters, the next larger size outlets 42 may have a diameter D in the range of 2.89 to 3.01 millimeters and a flow path length L in the range of 11.13 to 11.59 millimeters, and the largest outlets 42 may have a diameter D in the range of 3.91 to 4.07 millimeters and a flow path length L in the range of 13.86 to 14.42 millimeters.

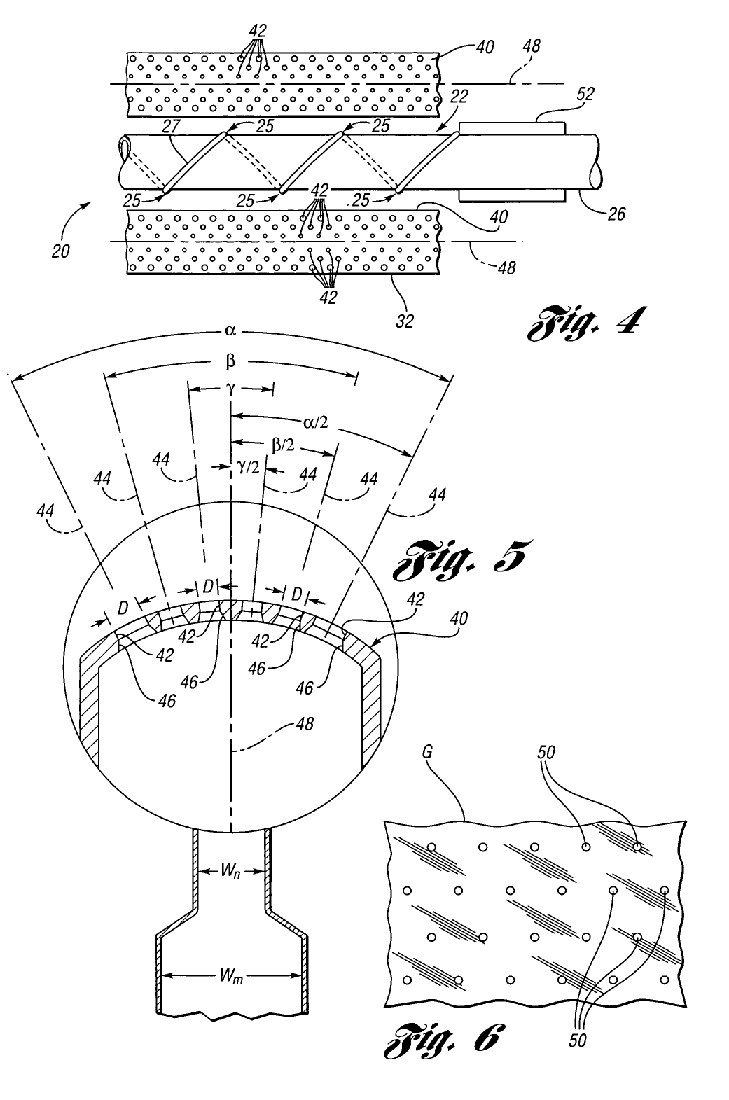

In the embodiment shown in FIG. 4, on each side of a bisecting plane 48 of each flow control member 32, the smallest size outlets 42 are located closest to the plane 48 laterally intermediate the next larger size outlets 42, which have a greater angle of incidence, and in alignment with the largest size outlets 42, which have the greatest angle of incidence. Furthermore, the smallest size outlets 42 on each side of the plane 48 are located laterally intermediate the smallest size outlets 42 on the other side of the plane 48. With such a configuration, the outlets 42 may be spaced and oriented to provide impingement locations 50 in an equilateral triangular pattern on a conveyed glass sheet G, as shown in FIG. 6. Such a pattern allows the impingement locations 50 to be positioned as close as possible to each other, while still maintaining sufficient area for the spent quenching fluid to escape after impingement with the glass sheet G.

Referring to FIGS. 1 and 3, each upper blasthead 28 may also include a set of upper roll mimics 51 located above the conveyor rolls 22 in a vertically aligned relationship. The roll mimics 51 have a size and shape that generally mimics the fluid flow effect of the conveyor rolls 22. For example, as shown in FIG. 3, each roll mimic 51 may be a stamped channel having a curved W-shaped cross-section. Alternatively, the roll mimics 51 may have any suitable shape. Moreover, the roll mimics 51 may be connected to and supported by a respective upper blasthead 28 and/or the frame 24.

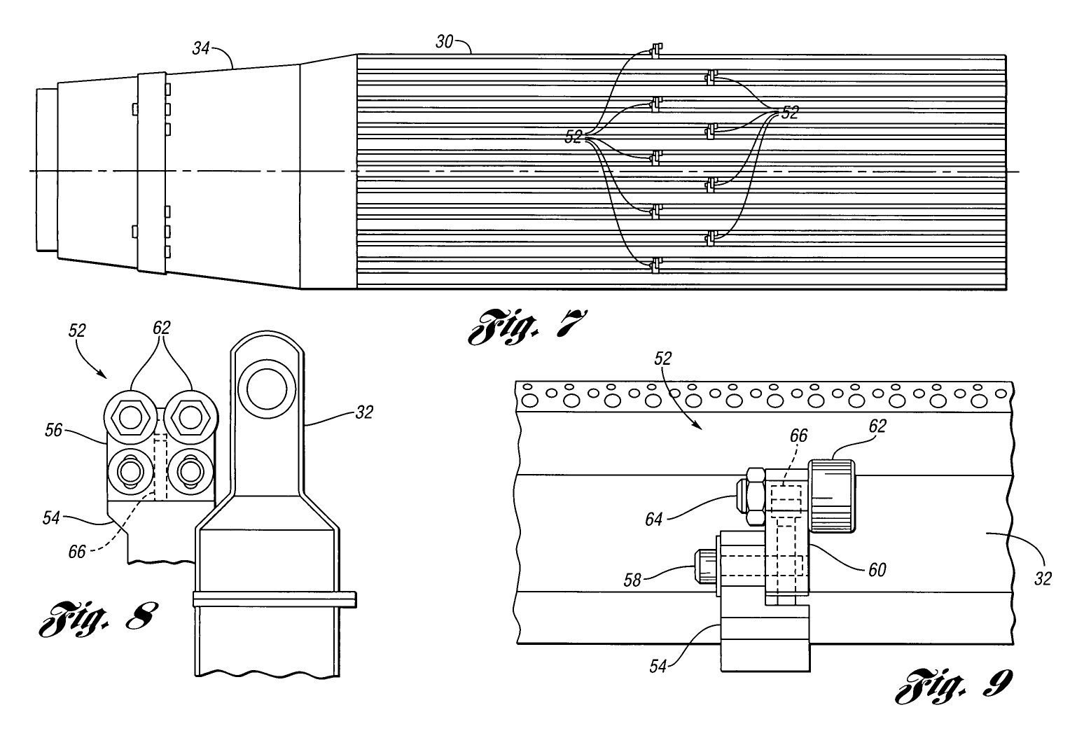

Referring to FIGS. 3 and 7-9, each lower blasthead 30 may also include one or more roll supports 52 that are each configured to support an intermediate portion of a respective conveyor roll 22. While each support 52 may have any suitable configuration, in the embodiment shown in FIGS. 8 and 9, the support 52 includes a support portion 54 fixedly attached to a flow control member 32, such as by a welding process, and an adjustable portion 56 adjustably connected to the support portion 54, such as with screws 58 or other fasteners.

The adjustable portion 56 includes a main body 60 and one or more followers 62 that are each movably attached to the main body 60 such as with a bolt 64 or other fastener. The followers 62, which may be rollers for example, are engageable with an intermediate portion of a respective roll 22 to maintain proper height of the intermediate portion during conveyance of a glass sheet G. The support 52 may also include a height adjustment member 66, such as a vertical screw, for adjusting height of the main body 60 when the screws 58 are loosened.

At contact locations between each support 52 and a respective roll 22, the helically wrapped support member 27 may be omitted from the roll 22 so that the followers 62 directly engage the roll body 26. Furthermore, the supports 52 may be staggered, as shown in FIG. 7, so that the portions of the rolls 22 without the support members 27 may be staggered.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for quenching a heated glass sheet, the apparatus comprising:
a roll conveyor system for conveying the glass sheet in a direction of conveyance C generally along a plane of conveyance; and
upper and lower sets of flow control members respectively located above and below the plane of conveyance, each set including multiple flow control members that each have multiple outlets for supplying quenching fluid for impingement with the glass sheet in inclined directions both upstream and downstream with respect to the direction of conveyance C, each outlet providing a fluid flow path to the conveyed glass sheet, wherein for each flow control member viewed in a direction generally transverse to the direction of conveyance C, the flow paths define a maximum angle of less than 75 degrees.

2. The apparatus of claim 1 wherein for each flow control member viewed in the direction generally transverse to the direction of conveyance C, the flow paths define a maximum angle of less than 60 degrees.

3. The apparatus of claim 1 wherein for each flow control member viewed in the direction generally transverse to the direction of conveyance C, the flow paths define a maximum angle of less than 52 degrees.

4. The apparatus of claim 3 wherein each outlet has a hydraulic diameter D and each fluid flow path has a length L to the conveyed glass sheet, and wherein for each outlet, L/D is less than 4.5.

5. The apparatus of claim 1 wherein each flow control member has a curved exterior surface to which the outlets of the flow control member extend, and each curved surface has a radius of curvature of at least 2.54 centimeters (1 inch).

6. The apparatus of claim 5 wherein each curved surface has a radius of curvature of at least 2.79 centimeters (1.10 inches).

7. The apparatus of claim 1 wherein each outlet has a hydraulic diameter D and each fluid flow path has a length L to the conveyed glass sheet, and wherein for each outlet, L/D is less than 4.5.

8. The apparatus of claim 7 wherein for each outlet, L/D is less than 4.2.

9. The apparatus of claim 1 wherein each flow control member has a nozzle portion that includes the respective outlets of the flow control member, and a main body portion connected to the nozzle portion for receiving quenching fluid and supplying the quenching fluid to the nozzle portion, each nozzle portion and each main body portion having an internal width generally in the direction of conveyance C, wherein for each flow control member, the internal width of the main body portion is at least 50 percent larger than the internal width of the nozzle portion.

10. The apparatus of claim 9 wherein for each flow control member, the internal width of the main body portion is at least 75 percent larger than the internal width of the nozzle portion.

11. The apparatus of claim 9 wherein the internal width of each nozzle portion is in the range of 2.54 to 3.81 centimeters (1 to 1.5 inches), and the internal width of each main body portion is in the range of 5.97 to 7.24 centimeters (2.35 to 2.85 inches).

12. The apparatus of claim 1 wherein the roll conveyor system includes multiple rolls extending generally transverse to the direction of conveyance C, and multiple supports that are each engageable with a respective roll for supporting an intermediate portion of the roll.

13. The apparatus of claim 12 wherein each support is attached to a respective flow control member.

14. A method for quenching a heated glass sheet, the method comprising:
conveying the glass sheet in a direction of conveyance C generally along a plane of conveyance; and
supplying quenching fluid to upper and lower sets of flow control members respectively located above and below the plane of conveyance, each set including multiple flow control members that each have multiple outlets for supplying the quenching fluid for impingement with the glass sheet in inclined directions both upstream and downstream with respect to the direction of conveyance C, each outlet providing a fluid flow path to the conveyed glass sheet, wherein for each flow control member viewed in a direction generally transverse to the direction of conveyance C, the flow paths define a maximum angle of less than 75 degrees.

15. The method of claim 14 wherein for each flow control member viewed in the direction generally transverse to the direction of conveyance C, the flow paths define a maximum angle of less than 60 degrees.

16. The method of claim 14 wherein for each flow control member viewed in the direction generally transverse to the direction of conveyance C, the flow paths define a maximum angle of less than 52 degrees.

17. The method of claim 16 wherein each outlet has a hydraulic diameter D and each fluid flow path has a length L to the conveyed glass sheet, and wherein for each outlet, L/D is less than 4.5.

18. The method of claim 14 wherein each flow control member has a curved exterior surface to which the outlets of the flow control member extend, and each curved surface has a radius of curvature of at least 2.54 centimeters (1 inch).

19. The method of claim 18 wherein each curved surface has a radius of curvature of at least 2.79 centimeters (1.10 inches).

20. The method of claim 14 wherein each outlet has a hydraulic diameter D and each fluid flow path has a length L to the conveyed glass sheet, and wherein for each outlet, L/D is less than 4.5.

21. The method of claim 20 wherein for each outlet, L/D is less than 4.2.

22. The method of claim 14 wherein each flow control member has a nozzle portion that includes the respective outlets of the flow control member, and a main body portion connected to the nozzle portion for receiving quenching fluid and supplying the quenching fluid to the nozzle portion, each nozzle portion and each main body portion having an internal width generally in the direction of conveyance C, wherein for each flow control member, the internal width of the main body portion is at least 50 percent larger than the internal width of the nozzle portion.

23. The method of claim 22 wherein for each flow control member, the internal width of the main body portion is at least 75 percent larger than the internal width of the nozzle portion.

24. The method of claim 22 wherein the internal width of each nozzle portion is in the range of 2.54 to 3.81 centimeters (1 to 1.5 inches), and the internal width of each main body portion is in the range of 5.97 to 7.24 centimeters (2.35 to 2.85 inches).

25. The method of claim 14 wherein the conveying step comprises conveying the glass sheet on a conveyor system that includes multiple rolls extending generally transverse to the direction of conveyance C, and multiple supports that are each engageable with a respective roll for supporting an intermediate portion of the roll.

26. An apparatus for quenching a heated glass sheet, the apparatus comprising:
a roll conveyor system configured to convey the glass sheet in a direction of conveyance C generally along a plane of conveyance; and
upper and lower sets of flow control members respectively located above and below the plane of conveyance, each set including multiple flow control members that each have a nozzle portion including multiple outlets for supplying quenching fluid for impingement with the glass sheet, and a main body portion connected to the nozzle portion for receiving the quenching fluid and supplying the quenching fluid to the nozzle portion, each nozzle portion and each main body portion having an internal width generally in the direction of conveyance C, wherein for each flow control member, the internal width of the main body portion is at least 50 percent larger than the internal width of the nozzle portion.

27. The apparatus of claim 26 wherein for each flow control member, the internal width of the main body portion is at least 75 percent larger than the internal width of the nozzle portion.

28. The apparatus of claim 26 wherein the internal width of each nozzle portion is in the range of 2.54 to 3.81 centimeters (1 to 1.5 inches), and the internal width of each main body portion is in the range of 5.97 to 7.24 centimeters (2.35 to 2.85 inches).

29. An apparatus for quenching a heated glass sheet, the apparatus comprising:
a conveyor system configured to convey the glass sheet in a direction of conveyance C generally along a plane of conveyance, the conveyor system including multiple rolls extending generally transverse to the direction of conveyance C, and multiple supports that are each engageable with a respective roll for supporting an intermediate portion of the roll; and
upper and lower sets of flow control members respectively located above and below the plane of conveyance, each set including multiple flow control members that each have multiple outlets for supplying quenching fluid for impingement with the glass sheet.

30. The apparatus of claim 29 wherein each support is attached to a respective flow control member.

31. The apparatus of claim 30 wherein the flow control members and opposite ends of each roll are supported by a support structure, and wherein the flow control members are movable with respect to the support structure for disengaging the supports from the rolls.

32. The apparatus of claim 29 wherein each support includes a fixed portion attached to a respective flow control member, and an adjustable portion that is movable with respect to the fixed portion for adjusting height of the support.
